(19) United States
(12) Patent Application Publication
(10) Pub. No.: US 2009/0091818 A1
(43) Pub. Date: Apr. 9, 2009

(54) ELECTRO-ACTIVE INSERT

(76) Inventors: Joshua N. Haddock, Roanoke, VA (US); William Kokonaski, Gig Harbor, WA (US); Ronald D. Blum, Roanoke, VA (US); Venkatramani S. Iyer, Roanoke, VA (US); Roger Clarke, Cambridge (GB); Peter Crossley, Melbourne (GB)

Correspondence Address: PEARL, COHEN, ZEDEK & LATZER, LLP, 1500 BROADWAY, 12TH FLOOR, NEW YORK, NY, 10036, US

(21) Appl. No.: 12/238,932

(22) Filed: Sep. 26, 2008

Related U.S. Application Data
(60) Provisional application No. 60/960,606, filed on Oct. 5, 2007.
(60) Provisional application No. 60/960,607, filed on Oct. 5, 2007.
(60) Provisional application No. 60/978,776, filed on Oct. 10, 2007.

(51) Int. Cl. G02B 3/10

(52) U.S. Cl. 359/319; 359/654

(57) ABSTRACT

Aspects of the present invention provide multi-focal electro-active lenses having one or more multi-focal electro-active inserts. The electro-active inserts can provide multiple optical power regions each capable of providing a desired optical power. An electro-active power region of the insert is capable of providing a variable optical power upon application of an electrical signal such as a time-varying voltage waveform. Electro-active inserts can be fabricated from any type of material and can be inserted into any type of bulk lens material. The electro-active inserts can be thin and flexible and can function independently of other optical components of the overall electro-active lens. Consequently, the electro-active inserts can be fabricated according to a uniform design using uniform materials, independent of the supplementing portions of the final lens. Index matching layers of the present invention can be used to reduce reflection losses between bulk lens material and electro-active insert interfaces.

### CROSS-REFERENCE TO RELATED APPLICATIONS

This application claims priority from and incorporates by reference in their entirety the following provisional applications:

U.S. Appl. No. 60/960,606, filed on Oct. 4, 2007;

U.S. Appl. No. 60/960,607, filed on Oct. 4, 2007; and

U.S. Appl. No. 60/978,776, filed on Oct. 10, 2007.

### BACKGROUND OF THE INVENTION

1. Field of the Invention

The present invention generally relates to lenses. More specifically, the present invention provides flexible electro-active inserts of minimal thickness that can be embedded into any bulk lens material to form an electro-active lens.

2. Background Art

Electro-active lenses are often designed with an electro-active optic that constitutes the bulk of a lens. That is, in many instances, a front portion of the electro-active optic is designed to function as a front lens component of the overall lens and a back portion of the electro-active optic is designed to function as a back lens component of the overall lens.

Combining the design and fabrication of a particular electro-active optic with the front and back lens components of the overall lens can reduce the flexibility and usefulness of an electro-active optic design. Specifically, the functionality of the electro-active optic cannot be designed separately and independently from the final front and back lens components. Further, the type of material that can be used to fabricate the electro-active optic may be restricted to the type of material used to fabricate the front and back lens components. Design and fabrication of an electro-active optic can therefore be very much lens specific. Consequently, a particular electro-active optic design cannot be easily adapted for use in a variety of lenses and applications.

As a result of these limitations of prior art electro-active lens designs, the cost and flexibility of electro-active optics have suffered. Accordingly, what is needed is an electro-active optic that can be designed to function independently and to comprise materials that differ from other lens component materials of an overall electro-active lens, thereby reducing the costs and increasing the usability of the electro-active optic.

### BRIEF DESCRIPTION OF THE DRAWINGS/FIGURES

FIG. 1A illustrates a front view of a lens having a refractive progressive addition region and a diffractive optical power region in accordance with an aspect of the present invention.

FIG. 1B illustrates a first variation in an orientation of the refractive progressive addition region and the diffractive optical power region depicted in FIG. 1A in accordance with an aspect of the present invention.

FIG. 1C illustrates a second variation in an orientation of the refractive progressive addition region and the diffractive optical power region depicted in FIG. 1A in accordance with an aspect of the present invention.

FIG. 1D illustrates a variation in the lens depicted in FIG. 1A in accordance with an aspect of the present invention.

FIG. 2 illustrates a lens comprising an electro-active insert in accordance with an aspect of the present invention.

FIG. 3 shows an exploded cross-sectional view of an electro-active insert in accordance with an aspect of the present invention.

FIG. 4 illustrates an alignment of a flexible reference substrate and a flexible diffractive substrate in accordance with an aspect of the present invention.

FIG. 5A illustrates a cross-section of a lens comprising an electro-active insert of the present invention.

FIG. 5B illustrates a cross-section of a lens comprising an electro-active insert of the present invention.

FIG. 6 illustrates an electro-active lens comprising index matching layers in accordance with an aspect of the present invention.

FIG. 7 provides a flowchart that illustrates operational steps for manufacturing an electro-active insert in accordance with an aspect of the present invention.

### DETAILED DESCRIPTION OF THE INVENTION

Aspects of the present invention provide multi-focal electro-active lenses having one or more multi-focal electro-active inserts. Multi-focal electro-active inserts of the present invention can comprise multiple optical regions. Each optical region can provide a desired optical power including zero optical power (i.e., plano). An optical region of an electro-active insert of the present invention may be electro-active and thus capable of providing a variable optical power upon application of an electrical signal such as a time-varying voltage waveform.

Electro-active inserts of the present invention can be fabricated from any type of material and can be inserted into any type of bulk lens material. The electro-active inserts can be thin and flexible and can function independently of other optical components of the overall electro-active lens. Consequently, the electro-active inserts can be fabricated according to a uniform design using uniform materials, independent of the supplementing portions of the final lens. Index matching layers of the present invention can be used to reduce reflection losses between bulk lens material and electro-active insert interfaces.

Electro-active inserts of the present invention can be applied to any type of optical lens or device including ophthalmic lenses such as, but not limited to, contact lenses, intra-ocular lenses, corneal in-lays, corneal on-lays, and spectacle lenses.

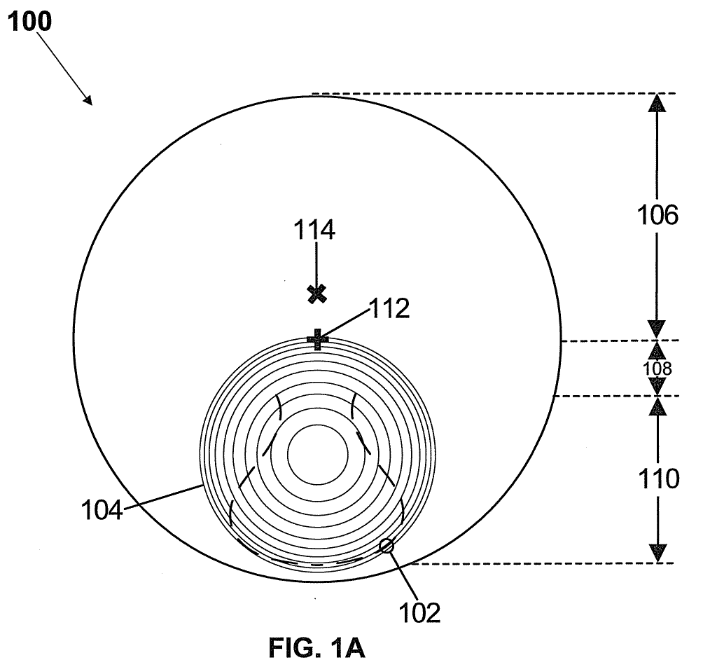

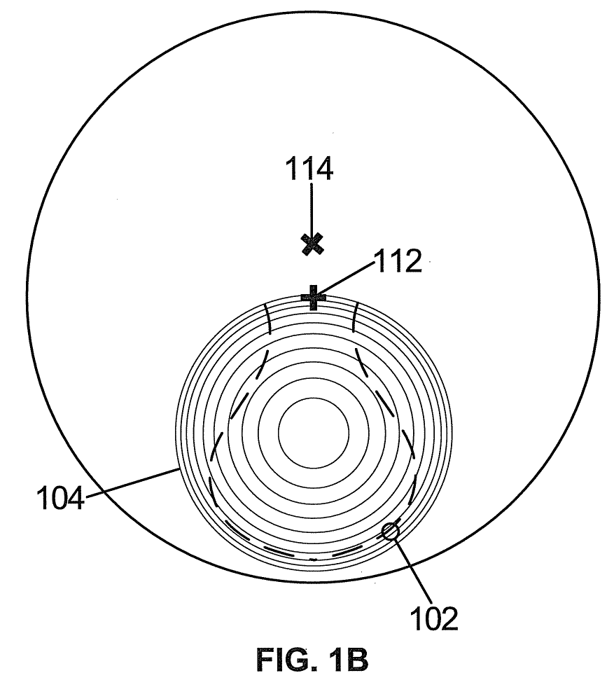

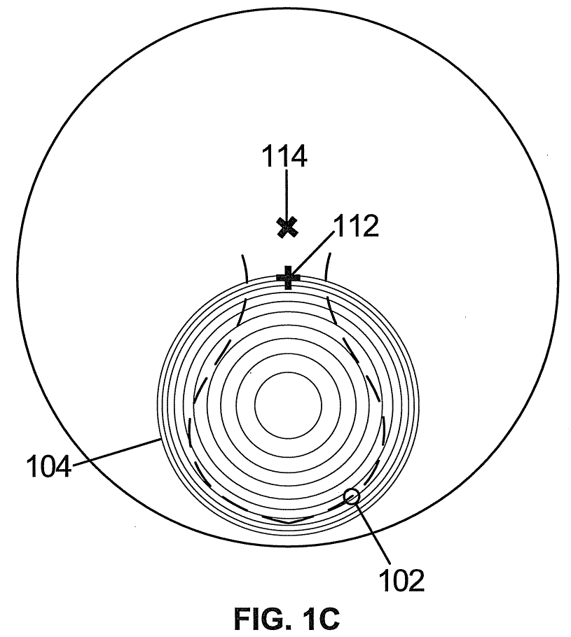

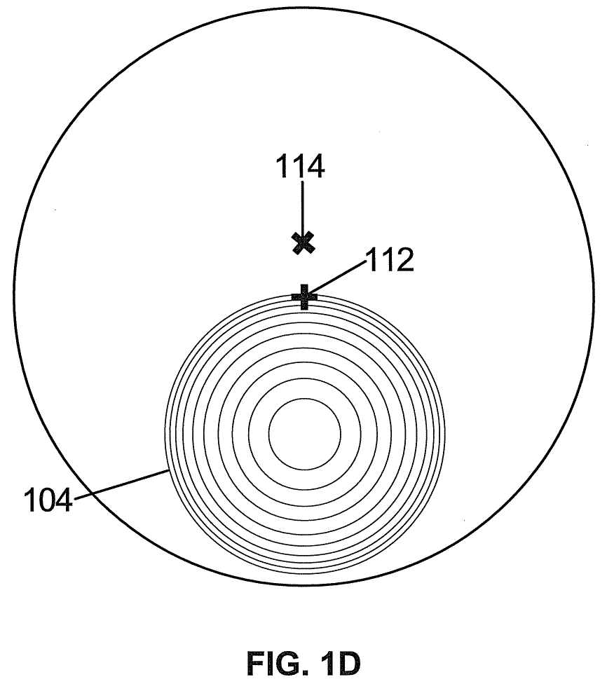

FIG. 1A shows a front view of a lens 100 having a refractive progressive addition region 102 and a diffractive optical power region 104 in accordance with an aspect of the present invention. The lens 100 can be a multifocal lens having at least a first optical power provided by the diffractive optical power region 104 and at least a second optical power provided by the refractive progressive addition region 102. The refractive progressive addition region 102 can provide a gradient of continuously monotonically increasing positive optical power. The diffractive optical power region 104 can be a static diffractive region. Alternatively, the diffractive optical power region 104 can be an electro-active diffractive region. Accordingly, the lens 100 can be an electro-active lens.

As shown in FIG. 1A, the diffractive optical power region 104 is in optical communication with the refractive progressive addition region 102. The diffractive optical power region 104 at least partially, and preferably largely, overlaps the refractive progressive addition region 102. The diffractive optical power region 104 and the refractive progressive addition region 102 can vary in shape, size, location and orientation (and therefore an amount of overlap) as described in U.S. patent application Ser. No. 12/166,526, filed on Jul. 2, 2008, which is hereby incorporated by reference in its entirety.

When used in combination, the refractive progressive addition region 102 can provide a wearer with an optical power that is less than the wearer's total needed near distance optical power correction and the diffractive optical power region 104 can provide the remaining optical power to provide the wearer's total needed near distance optical power correction. For example, the refractive progressive addition region 102 can provide a first portion of a total add power of the lens 100 and the diffractive optical power region 104 can provide a second portion of the total add power of the lens 100.

Using the diffractive optical power region 104 to supplement the optical power of the refractive progressive addition region 102 can reduce the overall optical power of the refractive progressive addition region 102. Since unwanted astigmatism is known to increase at a greater than linear rate as a function of the total add power of a refractive progressive addition region, supplementing the optical power of the refractive progressive addition region 102 reduces astigmatic and other unwanted effects that may include distortion, perceptual blur, or swim. Therefore, in accordance with an aspect of the present invention, the lens 100 can reduce these common undesirable effects while still providing a wearer with a total needed near distance optical power correction.

Based on the arrangement and optical powers of the refractive progressive addition region 102 and the diffractive optical power region 104, the lens 100 can provide multiple vision zones. For example, the lens 100 can provide a far distance vision region 106, a far-intermediate vision region 108, and an intermediate to near distance vision region 110 (e.g., an intermediate and near distance region 110). The intermediate to near distance vision region 110 may be located, for example, in the region where the refractive progressive addition region 102 has a maximum add power and can coincide with the center of the diffractive optical power region 104. The far-intermediate distance vision region 108 may be located, for example, in the region where the refractive progressive addition region 102 has less than its maximum add power and can coincide with an upper portion of the diffractive optical power region 104. Alternatively, the far-intermediate distance vision region 108 may be located, for example, in the region where the refractive progressive addition region 102 is absent and the diffractive optical power region 104 is present (i.e., in a region where the refractive progressive addition region 102 is not in optical communication with the diffractive optical power region 104). The far distance vision region 106 may be located, for example, in the region where the refractive progressive addition region 102 and the diffractive optical power region 104 are both absent.

Near distance vision (e.g., for reading) can describe vision at distances that range from approximately 10 inches to approximately 16 inches from the eye. Intermediate distance vision (e.g., for computer and other office work) can describe vision at distances that range from approximately 16 inches to approximately 24 inches from the eye. Far-intermediate vision can describe vision at distances that range from approximately 24 inches to approximately 6 feet from the eye. As an example, the optical power for correcting far-intermediate vision can be approximately 50% (and preferably approximately 40%) or less of the optical power for correcting near distance vision. These vision distances and desired powers for achieving appropriate vision correction in any vision distance can be adjusted or modified as will be appreciated by one skilled in the pertinent art(s).

The lens 100 has a geometric (or physical) center 112 and a fitting point 114. Typically, the far distance vision region 106 is located on an upper half of the viewing region of the lens 100 above the fitting point 114. The fitting point 114 can be designed to coincide with the location of the wearer's pupil and can mark the start of the optical power progression (along the progressive addition region 102) from the far distance vision region 106 to the intermediate to near distance vision region 110.

The diffractive optical power region 104 is shown in FIG. 1A to be located below the fitting point 114 and overlapping the geometric center 112 of the lens 100. However, it will be appreciated by one skilled in the pertinent art(s) that the diffractive optical power region 104 can be located anywhere on the lens 100. For example, the diffractive optical power region 104 can be centered at the fitting point 114 of the lens 100, such that the diffractive structures of the diffractive optical power region 104 are concentric with the fitting point 114.

In general, the diffractive optical power region 104 and the refractive progressive addition region 102 can be designed to overlap or overlay by any desired amount. As shown in FIG. 1A, the refractive progressive addition region 102 begins below a top of the diffractive optical power region 104 but is not so limited. FIGS. 1B and 1C illustrate possible variations in the orientation of the diffractive optical power region 104 and the refractive progressive addition region 102 relative to one another.

As shown in FIG. 1B, the refractive progressive addition region 102 begins at the top of the diffractive optical power region 104. As an example, the tops of the diffractive optical power region 104 and the refractive progressive addition region 102 can both begin between 2 mm and 10 mm below the fitting point 114. As an example, the refractive progressive addition region 102 can begin with plano optical power and can ramp up to a first optical power at a first distance below a start of the refractive progressive addition region 102. This first optical power can be any optical power ranging from 0.05 diopters (D) to 0.5 D (e.g., 0.1 D) while this first distance can be any distance ranging from 1 mm to 5 mm (e.g., 3 mm).

As shown in FIG. 1C, the refractive progressive addition region 102 begins above the top of the diffractive optical power region 104. Again, the top of the refractive progressive addition region 102 can be below the fitting point 114 with such a design. FIG. 1D illustrates a variation in which only the diffractive optical power region 104 is present.

In accordance with an aspect of the present invention, the diffractive optical power region 104 can be an insert. More specifically, the diffractive optical power region 104 can be a static or electro-active insert, or any combination thereof. As such, the lens 100 can be a static or electro-active lens that comprises a static or electro-active insert (or one or more static and/or electro-active inserts). In general, an insert of the present invention can comprise an optical element. The optical element can be a static or dynamic diffractive optical or region.

An electro-active insert of the present invention can largely be fabricated separately and independently from supplementing components of a final lens design. As an electro-active insert, the diffractive optical power region 104 can be fabricated to be exceptionally thin and flexible. Further, as an electro-active insert, diffractive optical power region 104 can be placed or arranged into any bulk lens material to form any final lens design. The ability to manufacture and use the electro-active diffractive optical power region 104 as an insert enables the insert to be manufactured in large volumes (e.g., in bulk) and to be used in conjunction with a wide variety of host lenses or lens materials. Overall, an aspect of the present invention enables any electro-active optic (e.g., an optic comprising a progressive region, refractive region, diffractive region, or any combination thereof) to be manufactured as an insert in order to realize the benefits of placing such an insert into any bulk lens material.

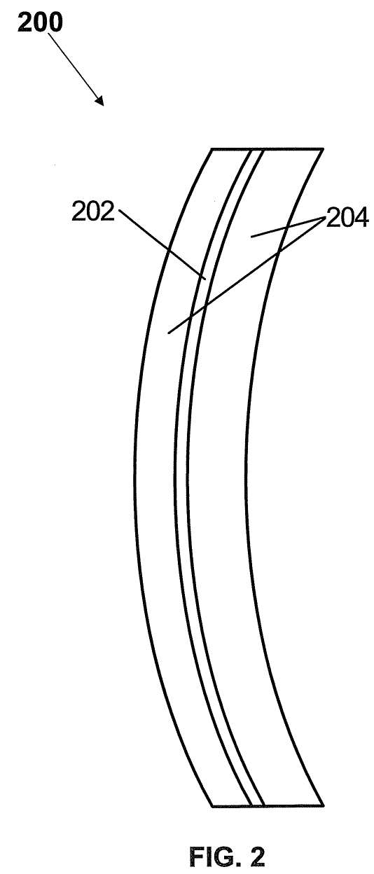

FIG. 2 illustrates a lens 200 comprising an electro-active insert 202 in accordance with an aspect of the present invention. The lens 200 can be an electro-active lens. The electro-active insert 202 is shown inserted into bulk lens material 204. The bulk lens material 204 can be any material and can comprise a lens of any design. That is, the bulk lens material 204 can comprise a front and/or back layer having any optical elements or design as will be appreciated by one skilled the pertinent art(s).

The electro-active insert 202 can comprise any static or electro-active optic. The lens 200 can be a finished, semi-finished or unfinished lens blank or a finished ophthalmic lens. The electro-active insert 202 of the present invention can be made in large volumes and can be inserted, embedded or used with a wide variety of bulk lens material 204. The electro-active insert 202 can be fabricated to be relatively thin and flexible by, for example, not having the electro-active insert 202 comprise the front and/or back optical surfaces/components of a final lens design. This allows the front and/or back optical surfaces/components of a final lens design to be created independently and the electro-active insert of the present invention to be introduced separately to supplement these elements in a final lens design. Any of the orientations of the refractive progressive addition region 102 and the diffractive optical power region 103 depicted in FIGS. 1A-1D can be realized using an insert of the present invention.

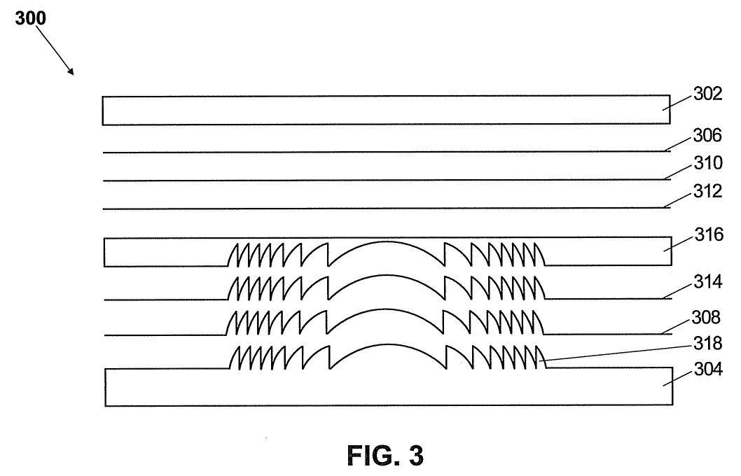

FIG. 3 shows an exploded cross-sectional view of an electro-active insert 300 in accordance with an aspect of the present invention. The electro-active insert 300 can be the electro-active insert 202 depicted in FIG. 2. The electro-active insert 300 can be disposed between any first optical element and any second optical element (not shown) in accordance with an aspect of the present invention. As such, the electro-active insert 300 can be positioned to be in optical communication with any surrounding or covering optical elements. Although the electro-active insert 300 is shown to be flat, it will be appreciated by one skilled in the pertinent art(s) that the electro-active insert 300 may alternatively be curved and may also be flexible.

The electro-active insert 300 can comprise, for example, an electro-active diffractive optical power region. The electro-active insert 300 can comprise a first substrate layer 302, a second substrate layer 304, transparent electrodes 306 and 308, an insulating layer 310, alignment layers 312 and 314 and electro-active material 316. Additional detailed description of the layers, overall function, construction and variations of the electro-active insert 300 may be found in U.S. patent application Ser. No. 12/018,048, filed on Jan. 22, 2008, and U.S. patent application Ser. No. 12/042,643, filed on Mar. 5, 2008, which are both hereby incorporated by reference in their entirety.

An example configuration of the electro-active insert 300 can be as follows: the first substrate layer 302 can comprise MR10, can have an index of refraction of 1.67 and can be considered to be a reference substrate; the second substrate layer 304 can also comprise MR10, can also have an index of refraction of 1.67 and can be considered to be a diffractive substrate; the transparent electrodes 306 and 308 can comprise indium tin oxide (ITO) and can be 20 nm thick; between the first substrate layer 302 and the transparent electrode 306 can be a 20 nm layer of SiO₂ (not pictured) that can increase transmission and promote adhesion while reducing reflection and tint; between the second substrate layer 304 and the transparent electrode 308 can also be a 20 nm layer of SiO₂ (not pictured) that can increase transmission and promote adhesion while reducing reflection and tint; the insulating layer 310 can comprise SiO₂ and can be 170 nm thick; the alignment layers 312 and 314 can each be 50 nm thick; between the alignment layer 314 and the transparent electrode 308 can also be an insulating layer (not shown) that can comprise SiO₂ that can be 170 nm thick; electro-active material 316 can comprise cholesteric liquid crystal (CLC) and can be, for example, between approximately 3 μm and 4 μm thick.

The first substrate layer 302 can have a flat surface topography and the second substrate layer 304 can have a surface relief diffractive topography formed of optical diffractive structures 318. Although the surface topography of the first substrate layer 302 is shown to be flat, any substantially featureless surface topography (e.g., curved) may be used. The transparent electrode 308, the alignment layer 314 and the region containing the electro-active material 316 can be formed along the second substrate layer 304. Accordingly, the transparent electrode 308, the alignment layer 314 and the region containing the electro-active material 316 can also have a surface relief diffractive topography (e.g., a surface relief diffractive topography that substantially matches the surface relief diffractive topography of the second substrate layer 304). As an alternative, the first substrate 302 can also have a surface relief diffractive topography. As another alternative, the second substrate 304 can have a flat surface topography and the first substrate 302 can have a surface relief diffractive topography.

The first substrate layer 302 and the second substrate layer 304 may be coated with the transparent electrodes 306 and 308, respectively. Transparent electrodes 306 and 308 may be uniformly deposited over the entire inner surfaces of the first substrate layer 302 and the second substrate layer 304, respectively.

The electro-active material 316 may be contained between the first and second substrate layers 302 and 304. The electro-active material 316 may be a liquid crystalline material such as, but not limited to, a nematic liquid crystal, a cholesteric liquid crystal (CLC), a smectic liquid crystal, a polymer dispersed liquid crystal, or a polymer stabilized liquid crystal.

The alignment layers 312 and 314 align the molecules of the electro-active material 316 in a predetermined direction relative to the substrate layers 302 and 304. The alignment layers 312 and 314 may be composed of, for example, a polyimide material (for mechanical buffing) or a photosensitive material (for polarized UV optical alignment).

The transparent electrodes 306 and 308 may be electrically connected to a controller (not shown), for example, via electrical contacts (not shown). The insulating layer 310 can be disposed between the transparent electrodes 306 and 308 to prevent electric conduction (i.e., electrical shorting) between the transparent electrodes 306 and 308. The controller can apply voltages to the transparent electrodes 306 and 308 predetermined to cause an electric field to form across the electro-active material 316 as well as any other layers between the transparent electrodes 306 and 308. The electric field can change the orientation of the molecules of the electro-active material 316, thereby changing the refractive index of the electro-active material 316. The change in refractive index of the electro-active insert 300 is predetermined to cause a diffractive pattern in the electro-active material 316 to provide a desired optical power.

When the electro-active material is a polarization sensitive liquid crystalline material such as, for example, a nematic liquid crystal, two electro-active elements are preferably used. The two electro-active elements are positioned in series and have alignment layers with orthogonal alignment directions to allow equal focusing of incident light of any polarization state. A more detailed description of such embodiments may be found in U.S. patent application Ser. No. 10/863,949 filed on Jun. 9, 2004, which is incorporated herein by reference in its entirety.

The reference substrate 304 can be approximately 3 to 4 μm thick. Accordingly, the reference substrate 304 can be the largest contributor to the overall thickness of the electro-active insert 300. Overall, the electro-active insert 300 can be fabricated to have an overall thickness, for example, ranging from approximately 50 μm to 1000 μm.

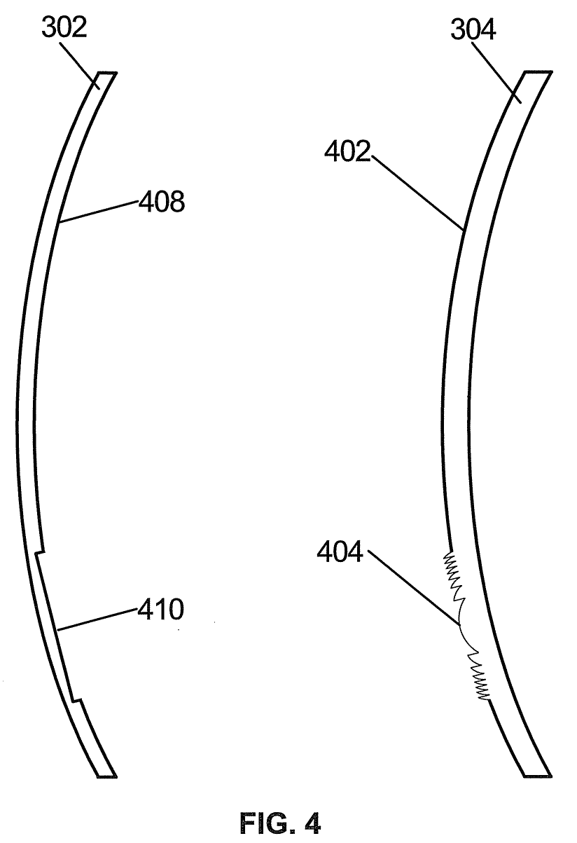

FIG. 4 illustrates an alignment of the flexible reference substrate 302 and the flexible diffractive substrate 304 depicted in FIG. 3. The reference substrate 302 and the diffractive substrate 304 can comprise any workable thermo-plastic (e.g. polysulphone or polyetherimide) or thermo-set (e.g. Mistui MR10) material. The reference substrate 302 and the diffractive substrate 304 can be made of materials have any index of refraction such as, but not limited to, 1.67.

As shown in FIG. 4, an inner surface 402 of the diffractive substrate 304 comprises surface relief diffractive structures 404. The surface relief diffractive structure 404 can be the diffractive structures 318 depicted in FIG. 4. An inner surface 408 of the reference substrate 302 can comprise a corresponding recess 410 aligned with the surface relief diffractive structures 404. The recess 410 can be used to hold or contain electro-active material (e.g., CLC or the electro-active material 316 depicted in FIG. 3). As an alternative to a reference substrate 302 comprising a recess 410, the reference substrate 302 may have no recess (and may be absent altogether) and the diffractive substrate 304 can comprise both the surface relief diffractive structures 404 and a chamber for containing the electro-active material.

The substrates 302 and 304 depicted in FIG. 4 can be generated according to any known method for generating substrates as will be appreciated by one skilled in the pertinent art(s). For example, the overall curvature of the substrate 302 and 304 can be formed by thermo-forming. Additionally, as an example, the diffractive structure 404 and corresponding recess 410 can be formed by hot embossing.

The inner surfaces 402 and 408 of the substrates 304 and 302, respectively, can be coated with appropriate electrical and optical coatings. Such coatings can include materials for applying voltage to the electro-active material, aligning the electro-active material and increasing optical transmission. As an example, the inner surfaces 402 and 408 of the substrates 304 and 302, respectively, can be coated with the electrical and optical coatings depicted and/or described in relation to FIG. 3 above.

A pre-determined amount of electro-active material can be dispensed into the recess 410 of the reference substrate 302 after other optical and electrical coatings have been applied. The reference substrate 302 and the diffractive substrate 304 can then be brought into contact and adhered together. Adhering can be accomplished, for example, through the use of optical adhesives or thermal means such as laser welding.

An electro-active insert formed from the reference substrate 302 and the diffractive substrate 304 can be inserted into another lens, lens material or optic by, for example, casting or injection molding raw lens material around the electro-active insert (e.g., as is done with polarized sun lenses). Alternatively, an adhesive can be used to embed an electro-active insert of the present invention between separately fabricated lens components (e.g., the bulk lens material 204 depicted in FIG. 2).

Adhesives or adhesive coatings can be used to enhance chemical bonding between an electro-active insert of the present invention and one or more layers of surrounding bulk lens material. An adhesive coating can be applied on one or more of the surfaces that are to be bonded together. The adhesive coating can be applied by dip or spin coating techniques. As an example, adhesives comprising epoxy monomers, acrylic monomers and/or oligomers can be used. Example acrylic monomers and oligomers include: diethylene glycol diacrylate, hexanediol diacrylate, tetraethylene glycol diacrylate, isobornyl acrylate and methacrylate, dipentaerythritol pentacrylate, and tetrafurfuryl acrylate. Example epoxy monomers include: alkyl glycidal ethers, trimethylol propane triglycidal ether, and Bis-(3,4-epoxycyclohexyl) adipate.

Other commercially available adhesives that can be used include the following: UV curable adhesives LL 490, LL 4001, and 4L36 manufactured by Master Bond, Inc.; UV curable adhesives 3030, 3032, 3034, 3050 and 3101 supplied by Loctite Corp.; UV curable cyanoacrylate adhesive manufactured by Hernon Manufacturing, Inc; acrylic, epoxy, and polyurethane adhesives supplied by Bondpak; polyurethane, epoxy, and acrylic adhesives manufactured by National Adhesives; polyurethane adhesives manufactured by IPAC Corp.; and epoxy adhesives manufactured by Dunbar.

By fabricating the electro-active lens separately, the electro-active insert of the present invention can function independently of any optical elements that may cover the electro-active insert. Accordingly, any surrounding or covering optical elements, lenses, or bulk lens materials can be fabricated separately and independently from the electro-active insert of the present invention.

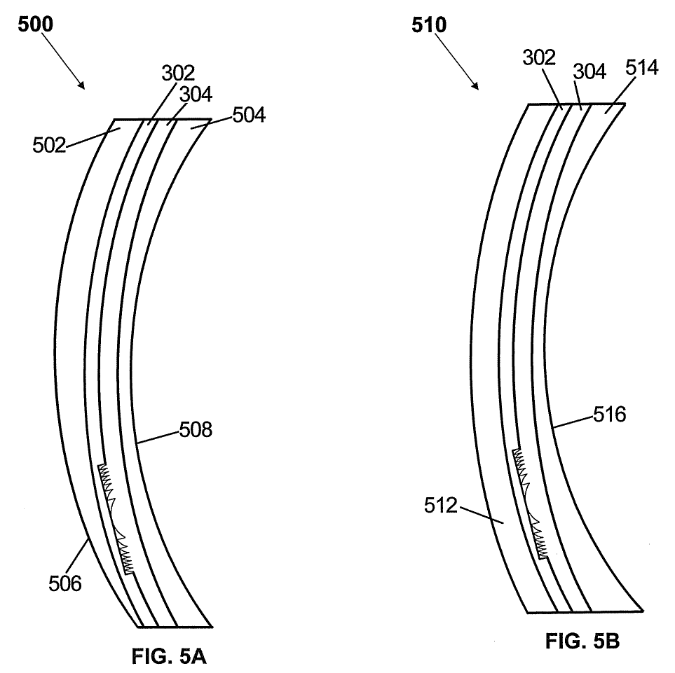

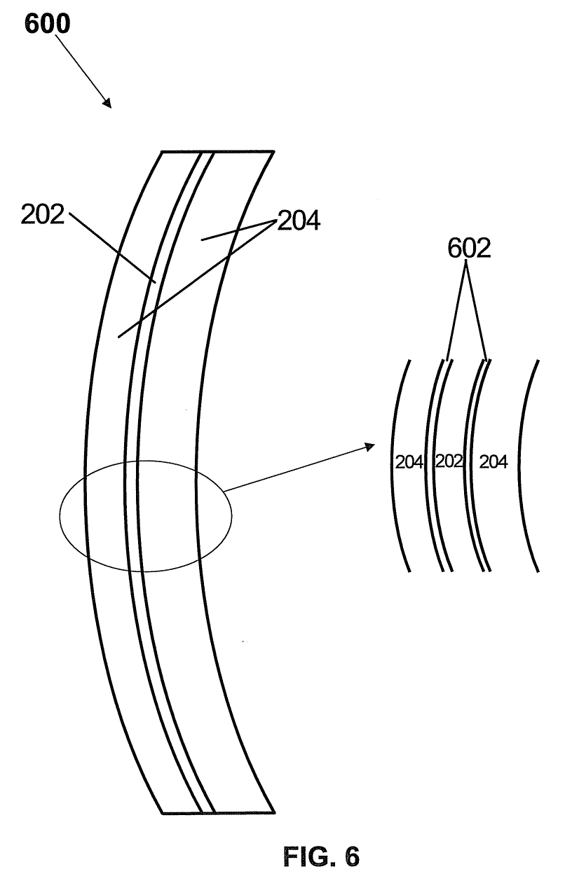

FIG. 5A illustrates a cross-section of a lens 500 comprising an electro-active insert of the present invention. Specifically, the lens 500 comprises the reference substrate 302 and the diffractive substrate 304 and the appropriate optical and electrical layers that can form an electro-active insert (e.g., the electro-active insert 300 depicted in FIG. 3). The lens 500 comprises a front lens 502 placed over the reference substrate 302 and a back lens 504 placed behind the diffractive substrate 304. The lens can be a finished, semi-finished, or unfinished lens blank or can be a final ophthalmic lens. The front lens 502 and the back lens 504 can comprise any lens or optical element or feature as will be appreciated by one skilled in the pertinent art(s). As an example, the front lens 502 can include a cast progressive surface 506. The cast progressive surface can be in optical communication with the diffractive structure of the electro-active insert. Further to the example, the back lens 504 can comprise a ground and polished or free-formed surface 508 finished according to a desired distance prescription.

Similar to FIG. 5A, FIG. 5B illustrates a cross-section of a lens 510 comprising an electro-active insert of the present invention. Specifically, the lens 510 comprises the reference substrate 302 and the diffractive substrate 304 and the appropriate optical and electrical layers that can form an electro-active insert (e.g., the electro-active insert 300 depicted in FIG. 3). The lens 510 comprises a front lens 512 placed over the reference substrate 302 and a back lens 514 placed behind the diffractive substrate 304. The lens can be a finished, semi-finished, or unfinished lens blank or can be a final ophthalmic lens. The front lens 512 and the back lens 514 can comprise any lens or optical element or feature as will be appreciated by one skilled in the pertinent art(s). As an example, the front lens 512 can include a finished front surface. Further to the example, the back lens 514 can comprise a free-formed progressive surface 516 with a desired distance prescription. The free-formed progressive surface 516 can be in optical communication with the diffractive structure of the electro-active insert.

An electro-active insert of the present invention (e.g., the electro-active insert 202 depicted in FIG. 2) can comprise a material having an index of refraction that is similar to the index of refraction of the material comprising the bulk lens (e.g., the bulk lens 204 depicted in FIG. 2) to which it is inserted. Under such a scenario, the difference between the indices of refraction of the insert and the bulk lens material may not result in substantial interfacial reflections between the surfaces of the electro-active insert and the bulk lens material. However, if the difference between the indices of refraction is large, then substantial interfacial reflections between the surfaces of the electro-active insert and the bulk lens material may result.

A measure of the amount of reflection of near-normal incident light at a boundary of two different materials can be given by:

$$R = {( \frac{{n}_{1} - {n}_{2}}{{n}_{1} + {n}_{2}} )}^{2} \qquad ( 1 )$$

where n₁ represent the index of refraction of the first material and n₂ represents the index of refraction of the second material. As shown by equation (1), the amount of reflection increases as the difference between n₁ and n₂ increases. If the difference is substantial, then a significant amount of reflection loss may result thereby reducing the transmission of a lens comprising an electro-active insert of the present invention.

To reduce possible reflection loss, an index-matching layer of the present invention can be placed between an electro-active insert and the bulk lens material. Specifically, a layer of material having an index of refraction close to the arithmetic mean of the index of refraction of the bulk lens material and the substrates used to construct an electro-active insert can be placed between the electro-active insert and the bulk lens material. The use of index matching layers allows the choice of material used to fabricate an electro-active insert of the present invention to be made independently from the choice of the material used to fabricate any bulk lens material.

FIG. 6 illustrates an electro-active lens 600 in accordance with an aspect of the present invention. The lens 600 comprises the electro-active insert 202 inserted into the bulk lens material 204. Index matching layers 602 are placed on either side of the electro-active insert 202. The index matching layers 602 can be placed along any portion of any interface between the electro-active insert 202 and the bulk lens material 204. The index matching layers 602 can reduce reflections that may result if the electro-active insert 202 and the bulk lens material 204 were in direct contact. Specifically, the reflections resulting from light passing through the bulk lens material 204 to the index matching layer 602 and then to the electro-active insert 202 can be made to be less than the reflections resulting from light passing through the bulk lens material 204 to the electro-active insert 202 directly. This result can be provided in accordance with the present invention on either interface or surface of the electro-active insert 202.

The index matching layers 602 can have the same or different indices of refraction. The index matching layers 602 may have the same indices of refraction when the bulk lens material 204 has a constant index of refraction—for example, when the front and back layers of the bulk lens material 204 have the same index of refraction. Alternatively, the index matching layers 602 may have different indices of refraction when the bulk lens material 204 has different indices of refraction—for example, when the front and back layers of the bulk lens material 204 have different indices of refraction.

As an example, the bulk lens material 204 can have an index of refraction of n1, the index matching layers 602 can have an index of refraction of n2 and the electro-active insert 202 can have an index of refraction of n3.

The index of refraction n2 can be selected so as to reduce interfacial reflections that would arise due to light passing directly from the bulk lens material 204 to the electro-active insert 202 (i.e., from n, to n3 directly). The index of refraction n2 can be, but is not limited to, an index of refraction that is the average of the indices of refraction n, and n₃. As will be understood by one skilled in the pertinent art(s), this selection of n₂ can be extended to the scenario where the bulk lens material 204 exhibits different indices of refraction on the front and back surfaces of a lens.

Additionally, as will be understood by one skilled in the pertinent art(s), this selection of n2 can be extended to the scenario where the insert substrates 302 and 304 exhibit different indices of refraction.

The index matching layer 602 can be of any thickness including, but not limited to, an optical thickness (product of physical thickness with refractive index) equal to one-quarter of an optical wavelength incident on the lens 600, as will be understood by one skilled in the pertinent art(s). This may be expressed mathematically as:

$${\overline{n}}_{λ} d = \frac{λ}{4} \qquad ( 2 )$$

where n̅_{λ} is the arithmetic mean of the refractive index values of the two adjacent materials at the design wavelength, d is the thickness of said index matching layer, and λ is the design wavelength.

Typically, the design wavelength of a lens is approximately equal to the photopic response of the human eye, or approximately 550 nm. By way of example only, consider an electro-active insert 202 with a refractive index of 1.67 at 550 nm buried within a bulk lens material 204 having a refractive index of 1.50 at 550 nm. According to equation (2) above, the thickness of the index matching layer 602 can be calculated to be approximately 86.8 nm for a design wavelength of 550 nm.

The index matching layers 602 can also serve as an adhesive or as adhesion promotion layers between the electro-active insert 202 and the bulk lens material 204. Further, the index-matching layers 602 can also reduce the visibility of the electro-active insert 202 to the human eye.

Overall, the use of index matching layers in accordance with the present invention enables an electro-active insert of the present invention to be fabricated from a material without regard to the material of a bulk lens to which it will be inserted. That is, the index matching layers can make an electro-active insert materially independent from the material used to construct the bulk lens. Accordingly, an aspect of the present invention enables electro-active inserts to be fabricate from a single design/material and then used in a wide variety of bulk lens materials by adjusting the properties of any index matching layers.

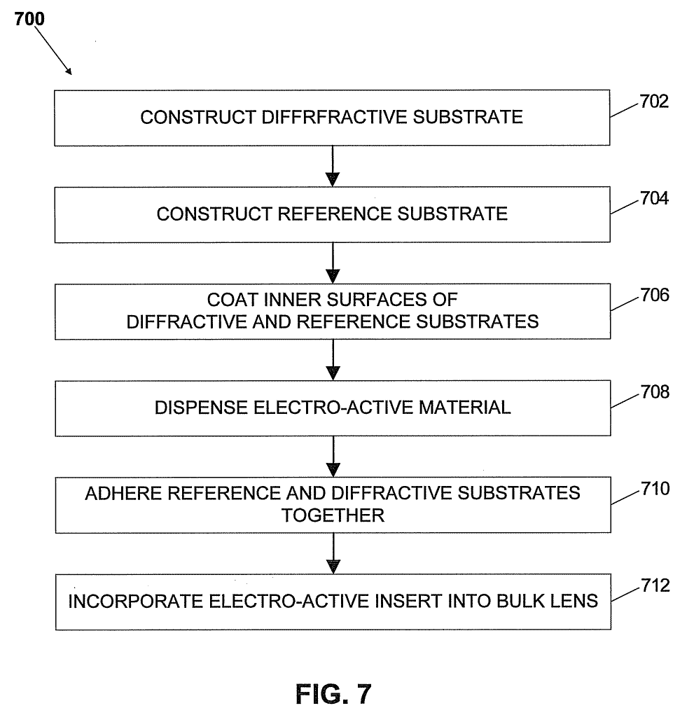

FIG. 7 provides a flowchart 700 that illustrates operational steps for manufacturing an electro-active insert in accordance with an aspect of the present invention. For example, the operational steps depicted in the flowchart 700 can be used to manufacture the electro-active insert 300 described in relation to FIG. 3. The invention is not limited to this operational description. Rather, it will be apparent to persons skilled in the relevant art(s) from the teachings herein that other operational control flows are within the scope and spirit of the present invention. In the following discussion, the steps in FIG. 700 are described.

At step 702, the diffractive substrate can be fabricated. The diffractive substrate can be fabricated to include desired surface relief diffractive structures. The diffractive structures can be fabricated by hot embossing. The overall curvature of the diffractive substrate can be formed by electro-forming.

At step 704, the reference substrate can be fabricated. The reference substrate can be fabricated to include a desired recess for holding electro-active material. The recess can be positioned to be in alignment with the corresponding diffractive structures of the diffractive substrate. The overall curvature of the reference substrate can be formed by electro-forming.

At step 706, the inner surfaces of the diffractive substrate and the reference substrate are coating with appropriate electrical and optical layers. The electrical and optical layers can be any of the electrical or optical layers described in relation to FIG. 3.

At step 708, a predetermined amount of electro-active material can be dispensed in the recess of the reference substrate.

At step 710, the reference substrate and the diffractive substrate are brought into contact and adhered together. The two substrates can be adhered by using optical adhesives. Alternatively, the two substrates can be adhered by thermal means such as laser welding. At the conclusion of step 710, an electro-active insert in accordance with the present invention can be formed.

At step 712, the electro-active insert formed via steps 702-710 can be incorporated into a bulk lens. Specifically, a front lens component or optic can be positioned onto a first side of the electro-active insert and a back lens component or optic can be positioned onto a second side of the electro-active insert. The front and back lens components can be directly or indirectly positioned over the surfaces of the electro-active insert. The electro-active insert can be positioned within the bulk lens by casting or injection molding raw lens material around the insert. Alternatively, the electro-active insert can be positioned within the bulk lens by using an adhesive to embed the electro-active insert. One or more index matching layers of the present invention can be inserted between the electro-active insert and either lens component of the bulk lens. An index matching layer may also serve as an adhesive layer or adhesion promoting layer.

### CONCLUSION

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A lens, comprising:
an electro-active insert comprising an optical element, wherein the electro-active insert has a thickness ranging from 50 μm to 1000 μm; and
a host lens comprising a refractive region, wherein the electro-active insert is embedded in the host lens.

2. The lens of claim 1, wherein the optical element comprises a diffractive optical power region.

3. The lens of claim 2, wherein the host lens comprises a progressive region.

4. The lens of claim 3, wherein the diffractive region and the progressive region are in optical communication.

5. The lens of claim 4, wherein the diffractive region provides a first portion of a total incremental add power of the lens and the progressive region provides a second portion of the total incremental add power of the lens.

6. The lens of claim 2, wherein the diffractive optical power region provides at least one optical power.

7. The lens of claim 2, wherein the diffractive optical power region is formed by embossing.

8. The lens of claim 1, wherein the electro-active insert provides at least one optical power.

9. The lens of claim 1, wherein the electro-active insert is thermo-formed.

10. The lens of claim 1, wherein the electro-active insert is formed by molding.

11. The lens of claim 1, wherein the electro-active insert is flexible.

12. The lens of claim 1, wherein an index of refraction of the electro-active insert is substantially equal to an index of refraction of the host lens.

13. The lens of claim 1, wherein an index of refraction of the electro-active insert is 1.67.

14. The lens of claim 1, further comprising at least one index matching layer.

15. The lens of claim 11, wherein an index of refraction of the at least one index matching layer is approximately equal to the arithmetic mean of an index of refraction of the electro-active insert and an index of refraction of the host lens.
